(19) United States
(12) Patent Application Publication
(10) Pub. No.: US 2024/0388169 A1
(43) Pub. Date: Nov. 21, 2024

(54) STATOR

(71) Applicant: Evolito LTD, Bicester Oxfordshire (GB)

(72) Inventors: Mukesh PATEL, Bicester (GB); Joel PORTER, Bicester (GB)

(21) Appl. No.: 18/665,142

(22) Filed: May 15, 2024

(30) Foreign Application Priority Data
May 15, 2023 (GB) 2307234.1

(51) Int. Cl. H02K 9/197; H02K 1/14; H02K 21/24

(52) U.S. Cl. CPC H02K 9/197; H02K 1/146; H02K 21/24

(57) ABSTRACT

A stator is provided that has a plurality of stator bars disposed circumferentially at intervals around an axis and a housing for enclosing the plurality of stator bars. Each of the stator bars has a set of windings wound therearound to form a stator coil stack for generating a magnetic field generally parallel to the axis. The stator housing forms a chamber that is flooded with cooling fluid. The housing is provided with a plurality of barriers, each of which is located between respective adjacent stator bars.

### FIELD OF THE INVENTION

The present invention relates to stators for electrical machines, in particular axial flux machines.

### BACKGROUND OF THE INVENTION

The move away from internal combustion engines to more electric machines, though initially focussed on automotive applications for land-based vehicles, is now finding a new focus in the demanding applications of aerospace. Because airlifting mass is costly, research effort is turning to maximise efficiencies, torque, speed and reducing mass of electric machines for aerospace applications where highest power density coupled with reliability are consistent drivers for this industry.

For many years radial flux motors/generators dominated aerospace electric machines, despite the invention of a different, axial flux topology. Several reasons can be attributed to the slow rise of axial flux machines, still in their infancy in aerospace, not least difficulty in displacing incumbent, known reliability technologies, but also not helped by challenges in efficient and consistent techniques for production. Axial flux electric machines present considerable challenges in manufacture and yet arguably, provide the best power dense topology for many aerospace drive, lift and generator applications, operating at speeds and torques that suit turbine, prop, and blade, drive sources. Advances continue to be made in axial flux topology, particularly improving power density and manufacturing techniques.

GB 2468018 describes an axial flux machine comprising a series of coils wound around pole pieces spaced circumferentially around the stator and spaced axially (i.e., parallel the rotational axis of the rotor) from the associated rotor. The rotor has two stages comprising discs provided with permanent magnets that face either end of each electromagnetic coil of the stator.

Reliability is important in many commercial and industrial fields but is well known to be of paramount importance in aerospace applications, where loss of capability of key functions can be catastrophic. Because need for reliability is so high, critical components in an aircraft will often have built in redundancy, or the component is duplicated and sometimes triplicated to allow for the instance of a component failing, in which case a duplicate is brought into play. For example, in the operation of air control surfaces, redundant secondary electrical machines are often employed in case of active system failure. Main drive engines are frequently duplicated, with the craft able to ‘fly’ should one unit fail.

A conflicting requirement for aerospace is light-weighting, and for every redundant system installed as insurance against a working component failure, the redundant system(s) is ‘carried’ as excess weight on every take-off, flight, and landing, adding significant cost.

An alternative to providing duplicate redundant systems, is to build-in fail-safe options. In this instance an electric machine may lose part of a critical component e.g., a component of a stator and remaining un-affected part(s) continues to operate providing sufficient power to ‘limp-home’ safely. CN201742274U teaches a radial electric machine wherein concentric radial stators have a radial rotor sandwiched between stator layers, each stator can operate independently allowing for failure in one stator whilst the other continues to operate. Such a system has more or less capability depending on which stator fails. A similar approach is found in US2019312490A1 in which concentric stators are also taught alongside a third axial stator and rotor, with redundancy provided by the radial stator pair.

U.S. Pat. No. 4,385,254 teaches a plurality of box-like dielectric screens surrounding extreme end connections between adjacent phase groups.

For high power density machines, liquid cooling is preferred and there is an added complexity of cooling for radial machines because end turns are vulnerable to overheating and are challenging to cool effectively whilst retaining fail-safe options.

There are several stator topologies for axial flux electric machines, and arguably the most power dense is that of the double rotor, single stator, yokeless and segmented armature (YASA) format in which a monolithic stator yoke is replaced by segmented stator bars. This format does not require a stator yoke magnetic return path which instead is provided by axially opposing rotors. A challenge of adopting a yokeless format is loss of structural rigidity provided by iron core yokes, but inventive ways have been applied providing lightweight robustness necessary for reliable operation of such machines.

While a comparatively low voltage potential difference exists between two adjacent winding layers on stator bars in any one phase group during the operation of both axial and radial flux electric machines, the potential difference being determined by the interturn voltage of one winding phase, the full line voltage of the stator winding can be present between two neighbouring phase groups for both axial and radial machines. High line voltages exceeding 1 kV and for some machines up to 10 kV can occur caused by stressful and fault operating conditions.

In these instances, there is risk of adjacent segmented armatures in YASA topology motors being subject to voltage difference sufficient to initiate flashover from one armature to the next, leading to cascade failure affecting several armatures.

We have therefore appreciated the need for an improved stator to alleviate or mitigate the problem of flashover arcing between adjacent stator segments.

### SUMMARY OF THE INVENTION

The present invention provides a stator in accordance with the independent claims appended hereto. Further advantageous embodiments are also provided with reference to the accompanying dependent claims.

We describe a stator for an axial flux machine, comprising: a plurality of stator bars disposed circumferentially at intervals around an axis, each of the stator bars having a set of windings wound therearound to form a stator coil stack for generating a magnetic field generally parallel to the axis, the plurality of stator coil stacks being arranged to provide a hollow region at the centre of the axis; a housing for enclosing the plurality of stator bars to form a chamber flooded with a cooling fluid, the housing having an inlet for receiving the cooling fluid and an outlet for expelling the cooling fluid; and plurality of barriers within the housing, each of the barriers being located between respective adjacent stator bars.

Advantageously, these barriers help prevent flashovers or cascade failures occurring between adjacent stator coil stacks.

The barriers may be dimensioned to permit at least a portion of the cooling fluid to flow between adjacent stator bars. One or more of the barriers may comprise a barrier formed of two barrier layers adjacent each other located between the respective stator bars.

One or more of the barriers may be electrically insulating.

One or more of the barriers are electrically conductive. The electrically conductive barriers may be electrically connected to ground or electrically connected to a voltage source.

Alternatively, at least one of the barriers may comprise a central barrier layer and two outer layers either side of the central barrier layer. The central barrier layer may be an electrically conductive layer, and the two outer layers are electrically insulating layers. The electrically conductive layer may be electrically connected to ground or electrically connected to a voltage source.

A first of the two outer layers may be formed to partially extend around a radially outward portion of a first stator bar, and a second of the two outer layers is formed to partially extend around a radially outward portion of a second stator bar, the first and second stator bars being respective adjacent stator bars.

In an alternative arrangement, the stator bar may be formed integrally with a barrier extending from the stator bar, the stator bar and barrier having a gap therebetween and wherein the stator coils are wound around the stator bar and in the gap between the stator bar and barrier.

One or more surfaces of the barriers may comprise holes, indents or detents therein.

We also describe a stator as described above, wherein: the housing may comprise two or more dividers arranged in the housing to form two or more chambers within the housing, each of the chambers being flooded with a cooling fluid and the dividers forming a fluid-tight seal between the two or more chambers, and wherein the stator bars may be arranged into at least a first group of stator bars in the a first chamber and a second group of stator bars in a second chamber, the first and second group of stator bars being isolated from each other by the dividers.

In the above-described stator, each of the two or more chambers may comprise an inlet port for supplying the cooling fluid, and an outlet port for drainage of the cooling fluid, and wherein the cooling fluid flows between the inlet and outlet ports.

In any of the arrangements described above, the housing and stator coil stacks may be arranged to permit the cooling fluid to flow back and forth between the inner and outer radius of the stator coil stacks. The stator may comprise one or more blocks disposed in the stator housing between the stator housing and one or more respective stator coil stacks, wherein the cooling fluid is forced through gaps between the stator coil stacks by means of the blocks.

We also describe an axial flux machine that may comprise: a stator according to any of the arrangements described above; a rotor comprising a set of permanent magnets and mounted for rotation about the axis of the machine, the rotor being spaced apart from the stator along the axis of the machine to define a gap between the stator and rotor.

The axial flux machine may also comprise a second rotor comprising a set of permanent magnets and mounted for rotation about the axis of the machine, the second rotor being spaced apart from the stator along the axis of the machine to define a gap between the stator and second rotor, and the second rotor being disposed on a side of the stator opposed to the rotor.

The machine may be a motor or a generator.

### LIST OF FIGURES

The present invention will be described, by way of example only, and with reference to the accompanying figures, in which:

FIG. 1 shows a schematic illustration of a yokeless and segmented armature machine;

FIG. 2 shows a schematic illustration of a yokeless and segmented armature machine;

FIG. 3 shows a schematic illustration of a yokeless and segmented armature machine;

FIG. 4 shows a schematic representation an axial flux stator;

FIG. 5 shows an example arrangement of the stator bars in an axial flux machine;

FIG. 6 shows an arrangement of a barrier between adjacent stator bars;

FIG. 7 shows arrangements of barriers;

FIG. 8 shows an arrangement of barriers between adjacent stator bars;

FIG. 9 shows an alternative barrier;

FIG. 10 shows example surface features of barriers;

FIG. 11 shows an example stator bar and integrated barrier; and

FIG. 12 shows a plan view of an axial flux stator utilising a cooling isolation arrangement.

### DETAILED DESCRIPTION OF THE PREFERRED EMBODIMENTS

In brief, the present invention relates to a stator that has a plurality of stator bars disposed circumferentially at intervals around an axis and a housing for enclosing the plurality of stator bars. Each of the stator bars has a set of windings wound therearound to form a stator coil stack for generating a magnetic field generally parallel to the axis. The stator housing forms a chamber that is flooded with cooling fluid. The housing is provided with a plurality of barriers, each of which is located between respective adjacent stator bars. Advantageously, these barriers help prevent flashovers or cascade failures occurring between adjacent stator coil stacks.

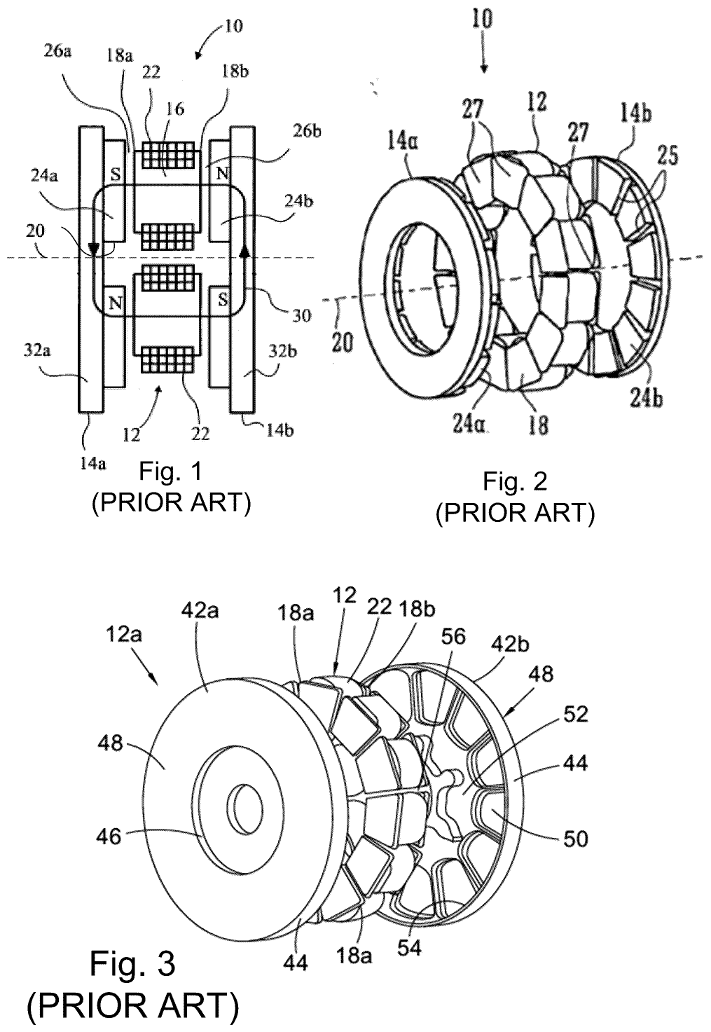

Referring first to FIGS. 1, 2 and 3, which are taken from WO2012/022974, FIG. 1 shows a schematic illustration of a yokeless and segmented armature machine 10.

The machine 10 comprises a stator 12 and two rotors 14a,b. The stator 12 is a collection of separate stator bars 16 spaced circumferentially about a rotation axis 20 of the rotors 14a,b. Each bar 16 has its own axis (not shown) which is preferably, but not essentially, disposed parallel to the rotation axis 20. Each end of each stator bar is provided with a shoe 18a,b which serves a physical purpose of confining a coil stack 22, which stack 22 is preferably of square/rectangular section insulated wire so that a high fill factor can be achieved. The coils 22 are connected to an electrical circuit (not shown) that, in the case of a motor, energizes the coils so that the poles of the resultant magnetic fields generated by the current flowing in the coils is opposite in adjacent stator coils 22.

The two rotors 14a,b carry permanent magnets 24a, b that face one another with the stator coil 22 between (when the stator bars are inclined—not as shown—the magnets are likewise). Two air gaps 26a,b are disposed between respective shoe and magnet pairs 18a/24a, 18b/24b. There are an even number of coils and magnets spaced around the axis of rotation 20 and, preferably, there are a different number of coils and magnets so that the coils do not all come into registration with the corresponding magnet pair at the same time and at the same rotational position of the rotor with respect to the stator. This serves to reduce cogging.

In a motor the coils 22 are energized so that their polarity alternates serving to cause coils at different times to align with different magnet pairs, resulting in torque being applied between the rotor and the stator. The rotors 14a,b are generally connected together (for example by a shaft, not shown) and rotate together about the axis 20 relative to the stator 12. The magnetic circuit 30 is provided by two adjacent stator bars 16 and two magnet pairs 24a,b and a back iron 32a,b for each rotor links the flux between the back of each magnet 24a,b facing away from the respective coils 22. The stator coils 16 are enclosed within a housing that extends through the air gap 26a, b and which defines a chamber supplied with a cooling medium.

Turning to FIG. 3, a stator 12a is shown in which the stator coils are located between plastic material clam shells 42a, b. These clamshells have external cylindrical walls 44, internal cylindrical walls 46, and annular radially disposed walls 48. In the prior art example of FIG. 3 the radial walls 48 include internal pockets 50 to receive the shoes 18a,b of the stator bars 16 and serve to locate the stator coil assemblies 16, 22, 18a,b when the two clam shell housings 42a, b of the stator 12a are assembled together. The stator housing 42a, b defines spaces 52 internally of the coils 22 and externally at 54 around the outside of the coils 22 and there are spaces 56 between the coils. The spaces 52,54,56 are interlinked defining a cooling chamber. Although not shown in FIG. 3, when assembled, the stator housing 42a,b is provided with ports that allow cooling medium such as oil to be pumped into the spaces 52, 54, 56 to circulate around the coils and cool them.

The coil cores may be laminated with the inter-lamination insulation parallel to the desired flux direction. However, the coil cores may also be formed from soft-iron particles coated with electrical insulation and moulded to a desired shape (soft magnetic composites—SMC), being bound together by the insulation matrix. Conveniently the shoes and stator bar may be formed separately and subsequently assembled.

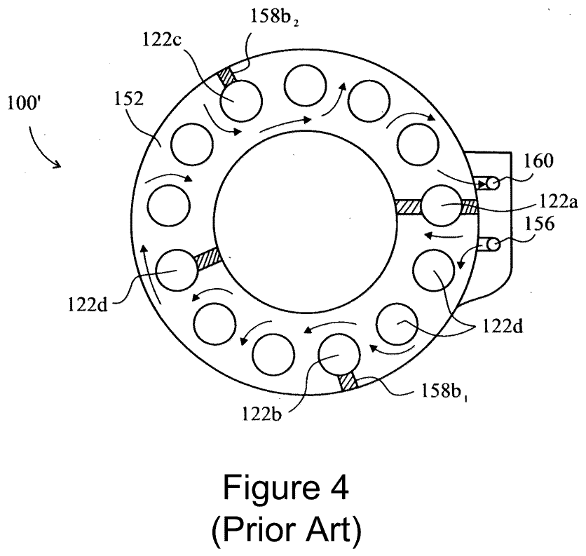

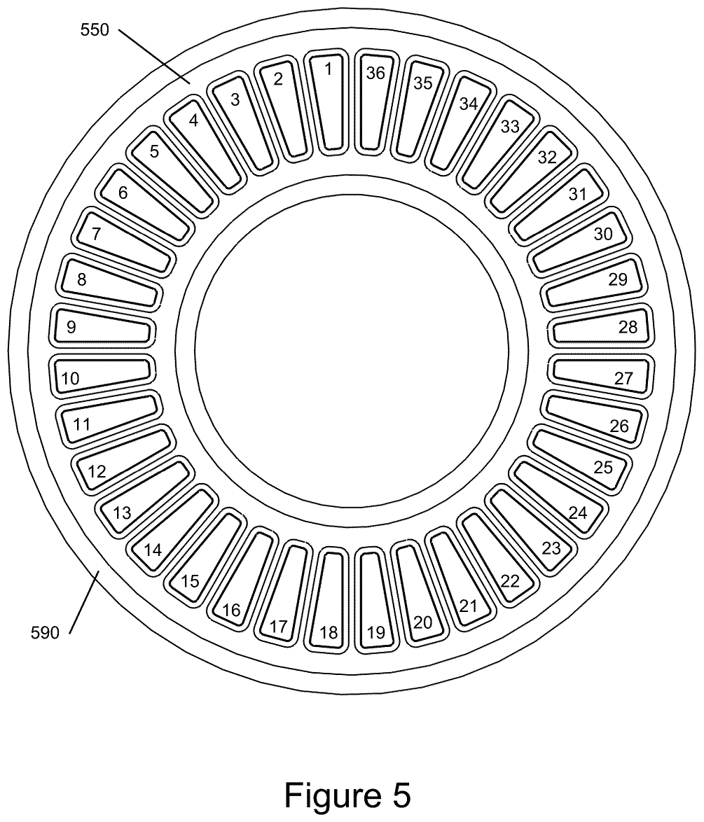

Turning to FIG. 4 a schematic representation is shown of a prior art axial flux stator from GB2468018 in which coolant inlet 156 provides a source of coolant which is guided in a meandering path back and forth between stator cores, by blockers 158b on outer and inner walls of the stator towards outlet 160.

Preferably there are an even number of stator cores 122 a,b,c,d, and coils (not shown) and magnets on opposing rotors (not shown) and, preferably, there are a different number of coils and magnets so that the coils do not all come into registration with the corresponding magnet pair at the same time and at the same rotational position of the rotor with respect to the stator.

For force balance reasons, electrical machine engineers seek to distribute stator impulse forces, e.g., for a 3-phase axial flux electric machine, adjacent armatures are powered in sequence with U, V, W phases, leading to a 12-core stator providing 4×3-phase symmetric quadrants with magnetic forces rotating in synchronisation with opposing rotor magnet poles.

In the arrangement shown in FIG. 5, 36 stator bars (labelled 1 to 36) are shown inside a housing 590. The walls and sides of the housing 590 provide a chamber 550 in which is contained a cooling fluid. Generally speaking the cooling fluid will flow between in inlet in the housing (not shown) and an outlet in the housing (also not shown). Whilst we describe an arrangement having 36 stator bars, the present invention is not limited to such an arrangement. Fewer stator bars may be present, or more stator bars may be present, depending on the structure of an axial flux machine that could utilise such a stator. As described above, each stator bar has a single phase multi-turn coil wound round to provide a stator coil stack that is electrically connected to a controller (not shown) via respective inputs.

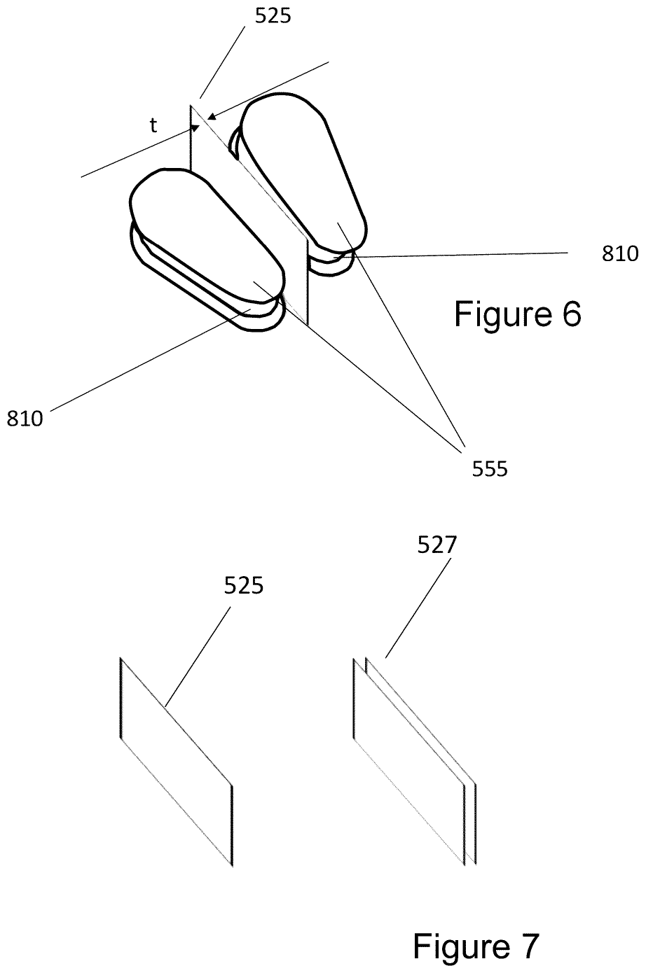

With reference to FIG. 6, stators of the present invention provide additional integrity and robustness against failure which may propagate from one segmented armature to its neighbour causing a ‘domino effect’ failure and affording this additional security are separators or barriers 525 which are placed between each adjacent stator bar 555 providing a physical barrier. Such physical barriers 525 prevent debris from being launched across gaps between stator segments, confining damage to a faulty segment preventing domino propagation.

Barriers 525 may not have the same internal dimensions of the housing 590, but may be of lesser dimensions in at least one axis, allowing coolant flow to remove heat from coils, stator cores and shoes and yet providing a thermal and physical insulating barrier between segmented armatures. Barriers 525 are advantageously electrical insulators, electrically floating or electrically connected to a voltage source.

Electric machines of the present invention are liquid cooled and armatures are submerged in flowing coolant providing cooling by removing heat from stator segment components including, coils, bar shoes, bars if surfaces are available, and coil supply busbar components.

Barriers 525 set between stator bars as shown in FIG. 6 may play a role in enhancing/maintaining the dielectric strength of cooling/insulating oil because the barriers block polarised contamination particle movement along electric field lines and stop space charge formations that once started can lead to oil breakdown.

For similar reasons coolant pumping is initiated prior to energising high reliability electric machines of the present invention so that coolant flow between stator segments additionally disrupts space charge formations generated by contamination.

For reasons of limiting water ingress/absorption, coolant oil is usually not changed on a regular basis, which might otherwise mitigate against particulate oil contamination and in this instance flashover barriers 525 provide a valuable improvement in stator reliability when high back emf, or similar high line voltage incidences occur.

In the instance of preventing arc breakdown between stator coils 810, barriers 525 are at least of a size to prevent line of sight between coils 810 at different potentials. The effect of barriers reducing space-charge formations can be increased by providing a gap between barriers as shown in FIG. 7 where single 525 and double 527 barriers are shown. In this instance space charge is stepped across two or more barriers.

Barriers 525 may be insulating materials that can tolerate being submerged in hot coolant oil and formed into thin sheets and can include as examples; mica, polyimide, polyester, high temperature nylon, epoxy composite, the list being exemplars and is not exhaustive.

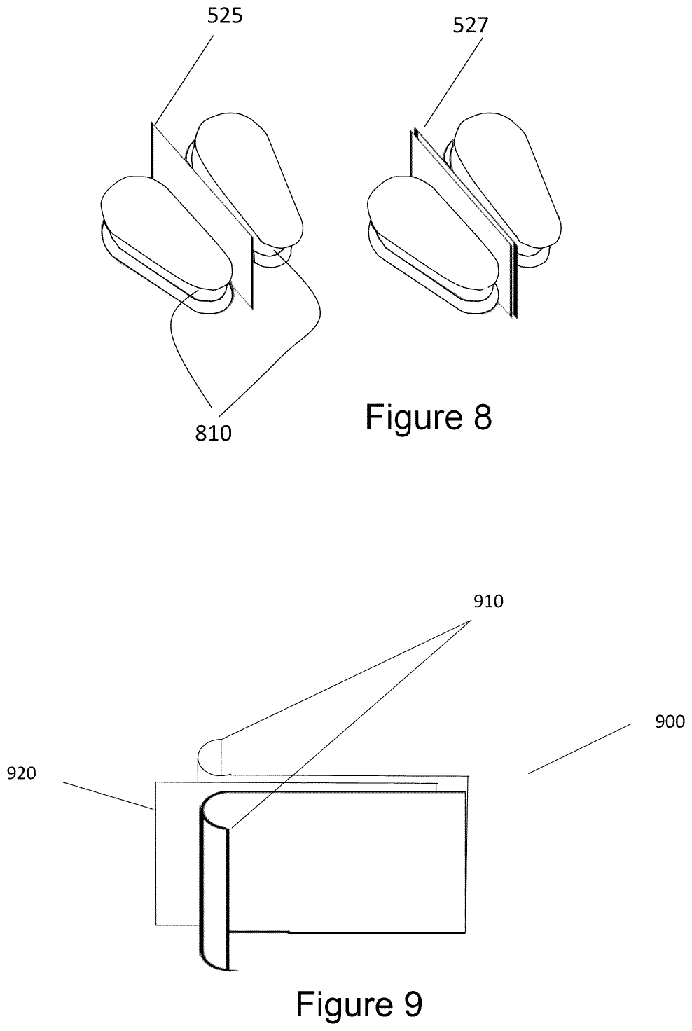

With reference to FIGS. 7 and 8, because the gap between armatures is small, it will be understood there is a trade-off of thickness (t) of barrier(s), such that they provide a reliable physical block and prevent flashover, whilst minimising their impact on coolant flow. Some barriers may comprise a barrier formed of two barrier layers adjacent each other that are located between the respective stator bars. This may provide additional protection from flashover or preventing cascade fails from propagating.

With reference to FIG. 9, for example for transitions between stator phase groups, there may be advantage in using a barrier comprising a central layer 920 and two outer layers 900, 910. The outer layers 900,910 may be insulated electrically conducting foil barriers with an electrically conducting foil 920 being grounded or tied to a voltage source and thereby reducing the local phase-to-phase field gradient, e.g., to that of phase-to-neutral.

Insulated foil barrier(s) 900 may be a composite sandwich of insulation layers 910 on either side of an electrically conducting sheet/foil 920. The electrically conducting sheet may be made from a variety of materials including copper or aluminium foil or an organic conductor. Such voltage reducing barrier layers may be connected to a grounded/neutral component of the electric machine. Ground in this instance may be a three-phase star-point.

For some applications there is value in the electrically conducting sheet/foil 920 being of high resistance i.e., >10¹⁰ ohms such that the barrier enables a lower voltage gradient, but not an easy electrical path.

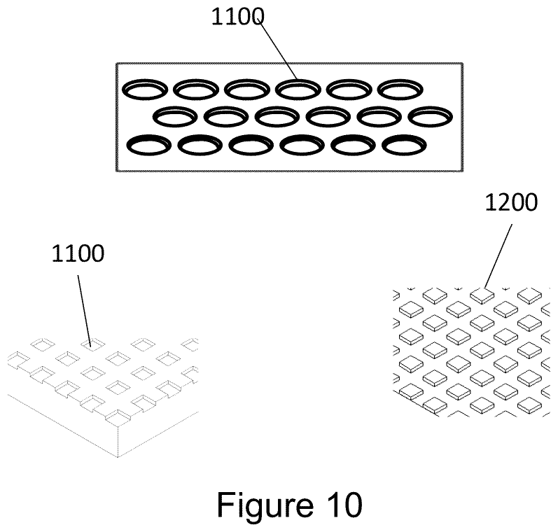

With reference to FIG. 10, good flow and associated heat removal characteristics of coolant between coils segments is useful for optimal running of motors of the present invention and a surprising feature of adding a barrier layer between armature coils is that barrier surface features e.g., holes 1100, indents 1200 and detents 1300 cause disturbance in coolant flow which improve heat removal from stator coils. Because barrier thickness (t) is small i.e. <1 mm and preferably <0.200 microns, surface features may be added i.e. not embossed into an otherwise flat substrate, or they may be embossed in a flat substrate. In either case surface features 1100, 1100, 1200 maybe formed on one side of barriers or on both sides of barriers. Surface features may include pin-seal embossments 1300, a common embossment for polymer surfaces.

Surface features, because they cause flow disturbance may also be usefully used to promote flow direction by adding such features to one side of a barrier causing drag whilst the opposite side flows faster, on exiting the confines between armatures, coolant has a preferred direction of flow.

Though electric machines of the present invention are yokeless and segmented armature topology, alternative axial flux topologies can benefit from the present invention.

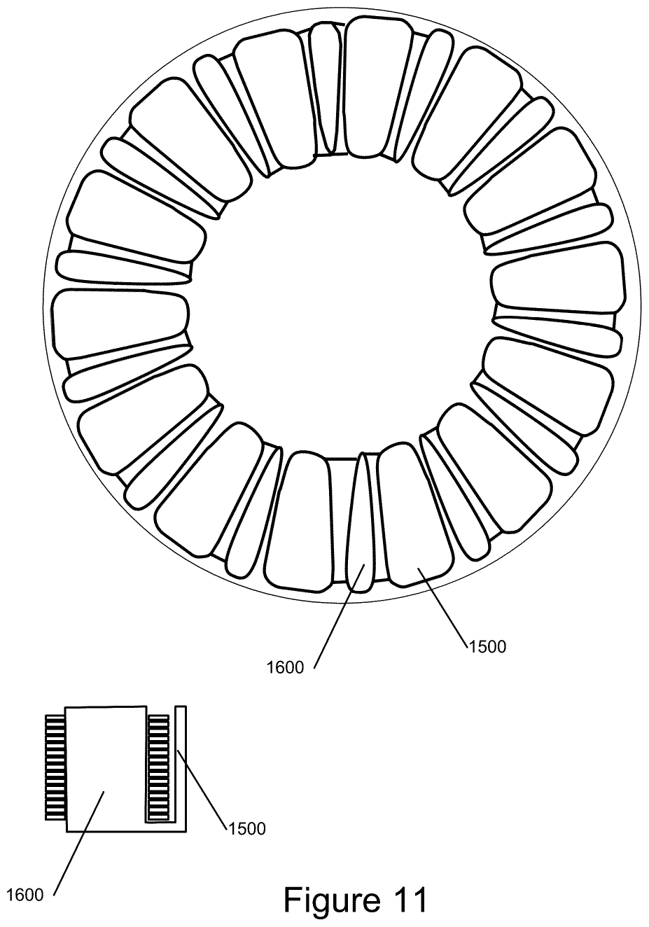

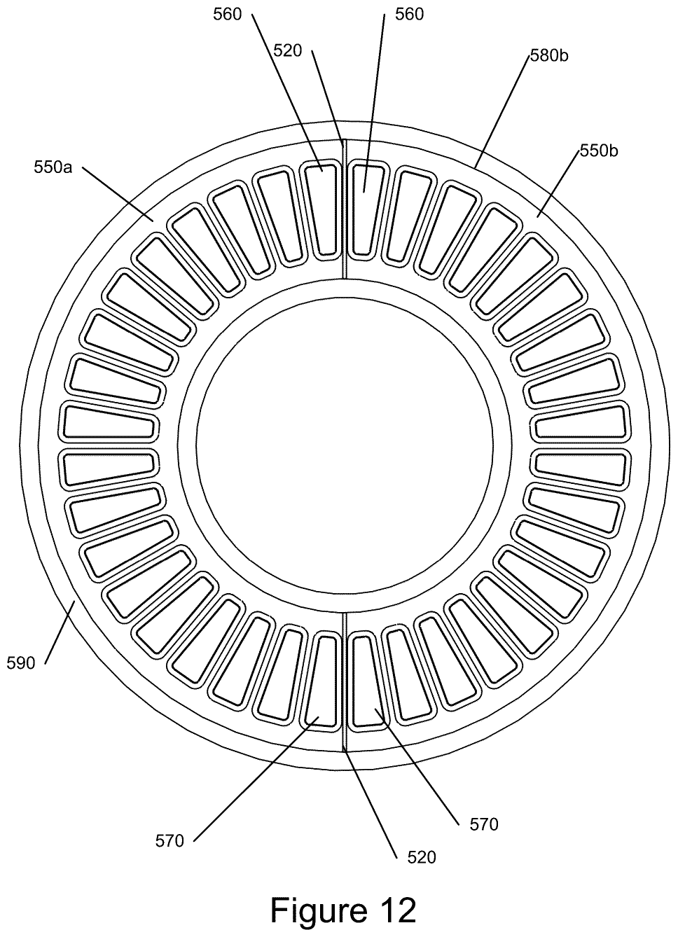

However, yokeless and segmented armature double rotor single stator topologies may be adapted to an alternative format as shown in FIG. 11 in which segmented normal sized armature stator bars 1500 are formed with attached narrow side bars 1600, such that a stator of this alternate format have coils on alternate cores are coil wound and alternate intervening narrow core holds no coil. In this instance stator bar pitch approaches that of the rotor pole pitch which increases flux linkage and improves phase back-emf waveform. This mode of using an unwound side bar not only improves motor characteristics, but also provides a solid physical barrier between coils.

Whilst barriers 525 may prevent flashovers or cascade failures between adjacent stator coil stacks, a failed stator coil stack is preferably isolated from the remainder of the stator coil stacks to prevent further degradation of the machine and to enable the machine to continue to run. One technique that may be used to enable this will be described below. In its broadest implementation, a cooling isolation technique utilises two or more independent chambers that are flooded with cooling fluid to cool the stator bars in each of the respective chambers.

The cooling isolation technique cools separately two or more physically isolated groups of stator bars within the stator. Such an arrangement provides redundancy should one cooling circuit fails, or should one or more of the stator bars in a particular grouping fail. In such a situation, the remaining cooling chambers may continue to cool the respective work stator bars. In such a scenario, the controllers driving the stator bars may be configured to drive only the stator bars that are being cooled. In this scenario, whilst the machine will not be able to provide the output power as before, this arrangement can at least implement a machine that can provide a limp-home mode, or sufficient output torque to complete the machine's task until it can be stopped safely.

In brief, the cooling chambers may be provided by using two or more dividers arranged in the housing to form the two or more chambers within the housing. The dividers form a fluid-tight seal between the two or more chambers. In this arrangement, the first group of stator bars is located in the first chamber of the housing and the second group of stator bars is located in the second chamber of the housing.

Turning to FIG. 12, which shows a plan view of an axial flux stator that utilising the cooling isolation arrangement, there is shown a motor stator containing two groups of stator bars within one stator housing. Each group is separated from the other by walls or dividers 520, which both delineates the two groups of stator bars, and provides a physical and liquid tight separation between the groups of stator bars, effectively dividing the stator housing into two chambers 550a, b. Each group of stator bars may be driven by a single controller, or each group may be driven by separate controllers. Under normal operation both groups are combined to operate as a single unit providing rotating magnetic poles that interact with rotor permanent magnets disposed on a rotor that causes them and the rotor to which they are attached to rotate.

As with FIG. 5, whilst 36 stator bars are shown in FIG. 12, these techniques are also valid for other arrangements of axial flux machine stators. That is, fewer than 36 stator bars may be present, or more than 36 stator bars may be present, depending on the structure of an axial flux machine that could utilise such a stator. As described above, each stator bar has a single phase multi-turn coil wound round to provide a stator coil stack that is electrically connected to a controller (not shown) via respective inputs. Barriers 525 are provided between one or more adjacent stator bars as described above with reference to FIGS. 6 to 11.

Each group of stator bars has its own coolant pump and flow from respective coolant inlets and outlets enabling an independent cooling circuit that offers redundancy should one lane need to be shut down, and isolation from the fault condition that caused that lane to be shut down.

As can be seen in FIG. 12, separation walls or dividers 520 not only divide the stator into two chambers, but also act as physical barriers and liquid seals between adjacent coils 560 and 570 in each half.

Such a physical barrier between coils is beneficial should burnout failure be experienced by one coil and the failure mode generates excessive heat in a neighbouring armature which also fails. With such a failure, walls 520 can prevent propagation of burnout failure from one independent stator to the other and in such an event one stator half may be shut down or downgraded in its operation whilst the unaffected stator half continues to operate independently.

For each stator half or chamber 550a,b to operate independently of the other, each group of stator bars contains its own cooling inlet (not shown) and outlet (not shown) ports and a port for mounting a sensor(s) to monitor stator coil temperature (not shown).

In stark contrast to normal electrical engineering rules, which seeks symmetry and force balance in electric machines, and as a consequence invokes duplicate redundant machines in-case of an active machine failure, the present invention includes a dual wound stator in a single stack, which under normal operation acts as a single high power dense unit of short axial length.

Under the exceptional circumstance of a fault condition in one of the stators, the formerly single electrical machine, figuratively splits into its component parts, enabling isolation of the faulty stator half, with the remaining working stator, taking a ‘limp-home’ i.e., a reduced power output role. Separate coolant flow, temperature monitoring and power supply for each stator half provides aerospace level fail-safe and redundant fail-safe operation for each stator.

For a stator of the present invention there is a common stator housing 590 separated into two segments/halves or chambers 550a,b. Each segment contains a respective group of stator bars. There are sealed, liquid tight, separating walls or dividers 520 between the segments.

At a system level there is an independent cooling circuit for each group and due to the sealed separating walls 520, should there be a leak or loss of coolant in one circuit it will not affect the other circuit and the machine can continue to operate. Similarly, if one group of stator bars has an electrical or thermal fault, that lane can be shut down without effecting the performance of the other lane.

Whilst we have discussed the stator being arranged into two separate chambers, each chamber covering respective halves of the stator, other arrangements or numbers of chambers may be possible. For example, the stator housing may be split into more chambers by the use of more dividers. The stator could be arranged into 3, 4, 6, 8 or more chambers. In such an arrangement, each chamber is provided with its own inlet and outlet, and each chamber is isolated from other chambers.

Each of the multiple chambers may be fed individually with cooling fluid, or they may be supplied cooling fluid in groups. Similar to the electrical isolation arrangements, for example, they may be two groups or more, but each group has one or more sets of stator bars arranged around the stator.

Each of the sets may be allocated one or other of a respective group of stator bars, where each set is located in its own chamber. These chambers may be individually supplied with cooling fluid. Alternatively, multiple sets of stator bars may be grouped together into two or more groups. These group allocations may alternate around the stator, so the first set of stator bars is allocated the first group of stator bars, the next set of stator bars is allocated the second group of stator bars and so on and so forth around the stator.

Whilst the sets of stator bars are isolated from neighbouring sets of stator bars (via the grouping), the cooling may be provided to multiple sets at the same time: all of the group 1 sets of stator bars may be supplied with cooling fluid from a first supply, and all of the group 2 sets of stator bars may be supplied with cooling fluid from a second supply.

Similar, the groupings of stator bars may also, or instead, be cooled as first, second, or, in some implementations, a third coolant supply.

Physical barriers between coils is beneficial should burnout failure be experienced by one coil and the failure mode generates excessive heat in a neighbouring armature which also fails. With such a failure, walls 520 can prevent propagation of burnout failure from one independent stator to the other and in such an event one stator half may be shut down or downgraded in its operation whilst the unaffected stator half continues to operate independently.

Axial flux machines of the present invention provide high reliability and fault tolerance by virtue of fusing two stators together in a single housing unit, wherein each armature may additionally be protected from its neighbour by separation walls which limit heat transfer between armatures and in a fault condition prevents damage from propagating between armatures. Either remaining working stator segment being capable of ‘limp-home’ function.

Throughout the description, we have been referencing an axial flux machine. In practice, this may be used as a motor or generator.

No doubt many other effective alternatives will occur to the skilled person. It will be understood that the invention is not limited to the described embodiments and encompasses modifications apparent to those skilled in the art lying within the scope of the claims appended hereto.

1. A stator for an axial flux machine, comprising:
a plurality of stator bars disposed circumferentially at intervals around an axis, each of the stator bars having a set of windings wound therearound to form a stator coil stack for generating a magnetic field generally parallel to the axis, the plurality of stator coil stacks being arranged to provide a hollow region at the centre of the axis;
a housing for enclosing the plurality of stator bars to form a chamber flooded with a cooling fluid, the housing having an inlet for receiving the cooling fluid and an outlet for expelling the cooling fluid; and
a plurality of barriers within the housing, each of the barriers being located between respective adjacent stator bars.

2. A stator according to claim 1, wherein the barriers are dimensioned to permit at least a portion of the cooling fluid to flow between adjacent stator bars.

3. A stator according to claim 1, wherein one or more of the barriers comprises a barrier formed of two barrier layers adjacent each other located between the respective stator bars.

4. A stator according to claim 1, wherein one or more of the barriers are electrically insulating.

5. A stator according to claim 1, wherein one or more of the barriers are electrically conductive.

6. A stator according to claim 5, wherein the electrically conductive barriers are electrically connected to ground or electrically connected to a voltage source.

7. A stator according to claim 1, wherein at least one of the barriers comprises a central barrier layer and two outer layers either side of the central barrier layer.

8. A stator according to claim 7, wherein the central barrier layer is an electrically conductive layer, and the two outer layers are electrically insulating layers.

9. A stator according to claim 8, wherein the electrically conductive layer is electrically connected to ground or electrically connected to a voltage source.

10. A stator according to claim 7, wherein a first of the two outer layers is formed to partially extend around a radially outward portion of a first stator bar, and a second of the two outer layers is formed to partially extend around a radially outward portion of a second stator bar, the first and second stator bars being respective adjacent stator bars.

11. A stator according to claim 1, wherein the stator bar is formed integrally with a barrier extending from the stator bar, the stator bar and barrier having a gap therebetween, and wherein the stator coils are wound around the stator bar and in the gap between the stator bar and barrier.

12. A stator according to claim 1, wherein one or more surfaces of the barriers comprises holes, indents or detents therein.

13. A stator according to claim 1, wherein:
the housing comprises two or more dividers arranged in the housing to form two or more chambers within the housing, each of the chambers being flooded with a cooling fluid and the dividers forming a fluid-tight seal between the two or more chambers, and
wherein the stator bars are arranged into at least a first group of stator bars in the a first chamber and a second group of stator bars in a second chamber, the first and second group of stator bars being isolated from each other by the dividers.

14. A stator according to claim 13, wherein each of the two or more chambers comprises an inlet port for supplying the cooling fluid, and an outlet port for drainage of the cooling fluid, and wherein the cooling fluid flows between the inlet and outlet ports.

15. The stator according to claim 1, wherein the housing and stator coil stacks are arranged to permit the cooling fluid to flow back and forth between the inner and outer radius of the stator coil stacks.

16. The stator according to claim 15, wherein the stator comprises one or more blocks disposed in the stator housing between the stator housing and one or more respective stator coil stacks, wherein the cooling fluid is forced through gaps between the stator coil stacks by means of the blocks.

17. An axial flux machine, comprising:
a stator according to claim 1;
a rotor comprising a set of permanent magnets and mounted for rotation about the axis of the machine, the rotor being spaced apart from the stator along the axis of the machine to define a gap between the stator and rotor.

18. The axial flux machine according to claim 17, comprising a second rotor comprising a set of permanent magnets and mounted for rotation about the axis of the machine, the second rotor being spaced apart from the stator along the axis of the machine to define a gap between the stator and second rotor, and the second rotor being disposed on a side of the stator opposed to the rotor.

19. The axial flux machine according to claim 17, wherein the machine is a motor or a generator.
